(19) United States
(12) Patent Application Publication
(10) Pub. No.: US 2026/0237793 A1
(43) Pub. Date: Aug. 13, 2026

(54) Electrode Stack and Battery System Including Electrode Stack

(71) Applicant: LG Energy Solution, Ltd., Seoul (KR)

(72) Inventors: Jae Hyeok Choi, Daejeon (KR); Sung Hyun Kim, Daejeon (KR); Dong Hun Song, Daejeon (KR); Ki Hyun Park, Daejeon (KR); Xu Yang, Daejeon (KR); Soo Hwang Lee, Daejeon (KR)

(73) Assignee: LG Energy Solution, Ltd., Seoul (KR)

(21) Appl. No.: 19/154,881

(22) PCT Filed: Jun. 20, 2024
(86) PCT No.: PCT/KR2024/008544

§ 371 Date: Aug. 8, 2025

(30) Foreign Application Priority Data
Jun. 23, 2023 (KR) 10-2023-0081266

(51) Int. Cl. H01M 50/103; H01M 4/70

(52) U.S. Cl. CPC H01M 50/103; H01M 4/70

(57) ABSTRACT

An electrode stack may include an upper surface forming the upper outer periphery of electrodes stacked in the vertical stacking direction, a lower surface forming the lower outer periphery of the electrodes, and side surfaces connecting the upper surface and the lower surface along the stacking direction, wherein the upper surface and the lower surface may be bent along the stacking direction, and when viewed from above, the upper surface may have corner portions formed in different shapes.

### CROSS-REFERENCE TO RELATED APPLICATIONS

The present application is a national stage entry under 35 U.S.C. § 371 of International Application No. PCT/KR2024/008544 filed on Jun. 20, 2024, which claims priority to Korean Patent Application No. 10-2023-0081266 filed on Jun. 23, 2023, the disclosures of each of which are incorporated herein by reference in their entirety.

### TECHNICAL FIELD

The present disclosure relates to an electrode stack and a battery system including the electrode stack.

### BACKGROUND

In order to address the high demand for new energy sources due to the depletion of petroleum resources and to solve the increasingly severe problem of environmental pollution, research and development on electric power generation based on eco-friendly energy sources are in progress. In particular, research on secondary batteries that can be repeatedly charged and discharged is being actively conducted, and various aspects such as materials, structures, processes, and stability of secondary batteries are being studied.

The secondary battery may include an electrode stack. In particular, when the density of the electrode stack itself is high or the electrode stack is mounted at a high density, energy efficiency may be increased and space efficiency may be maximized. The secondary battery may have an external shape corresponding to the shape of the electrode stack.

According to the prior art, simply mounting a secondary battery within a battery system (e.g., an electronic device) may degrade space efficiency and may not ensure sufficient battery capacity.

### SUMMARY

### Technical Problem

The present disclosure is designed to solve the problems of the related art, and therefore the present disclosure is directed to providing an electrode stack capable of maximizing space efficiency and battery capacity, and a battery system including the electrode stack.

### Technical Solution

An electrode stack according to an aspect of the present disclosure may include an upper surface forming the upper outer periphery of electrodes stacked in the vertical stacking direction, a lower surface forming the lower outer periphery of the electrodes, and side surfaces connecting the upper surface and the lower surface along the stacking direction, wherein the upper surface and the lower surface may be bent along the stacking direction, and when viewed from above, the upper surface may have corner portions formed in different shapes.

A battery system according to an aspect of the present disclosure may include a battery unit having a bending portion in a bent shape that defines a receiving space for accommodating an electrode stack therein, and an electrode stack disposed in the receiving space, wherein the electrode stack may include an upper surface forming the upper outer periphery of electrodes stacked in the vertical direction, a lower surface forming the lower outer periphery of the electrodes, and side surfaces connecting the upper surface and the lower surface along the stacking direction, wherein the upper surface and the lower surface may be bent along the stacking direction, and
when viewed from above, the upper surface may have corner portions formed in different shapes.

### Advantageous Effects

According to an aspect of the present disclosure, space efficiency within the battery system may be maximized.

According to an aspect of the present disclosure, usable battery capacity may be maximized.

### BRIEF DESCRIPTION OF THE DRAWINGS

FIG. 1 is a plan view of an electrode stack according to a first aspect of the present disclosure.

FIG. 2 is a side view of an electrode stack according to a first aspect of the present disclosure.

FIG. 3 is a perspective view of an electrode stack according to a first aspect of the present disclosure.

FIG. 4 is a plan view of an electrode stack according to a second aspect of the present disclosure.

FIG. 5 is a side view of an electrode stack according to a second aspect of the present disclosure.

FIG. 6 is a perspective view of an electrode stack according to a second aspect of the present disclosure.

FIG. 7 is a plan view of an electrode stack according to a third aspect of the present disclosure.

FIG. 8 is a side view of an electrode stack according to a third aspect of the present disclosure.

FIG. 9 is a perspective view of an electrode stack according to a third aspect of the present disclosure.

FIG. 10 is a conceptual view showing a battery system according to an aspect of the present disclosure.

### DETAILED DESCRIPTION

Hereinafter, aspects of the present disclosure will be described in sufficient detail with reference to the accompanying drawings to enable those having ordinary skill in the technical field pertaining to the present disclosure to easily carry out the present disclosure. However, the present disclosure may be embodied in many different forms and is not limited or restricted by the following aspects.

To clearly describe aspects of the present disclosure, an irrelevant description or a detailed description of related known technology that may unnecessarily obscure the gist of the present disclosure is omitted, and in affixing the reference numerals to the elements in each drawing, the identical or similar reference numerals are affixed to the identical or similar elements throughout the disclosure.

Additionally, it should be understood that the terms or words used in the disclosure and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

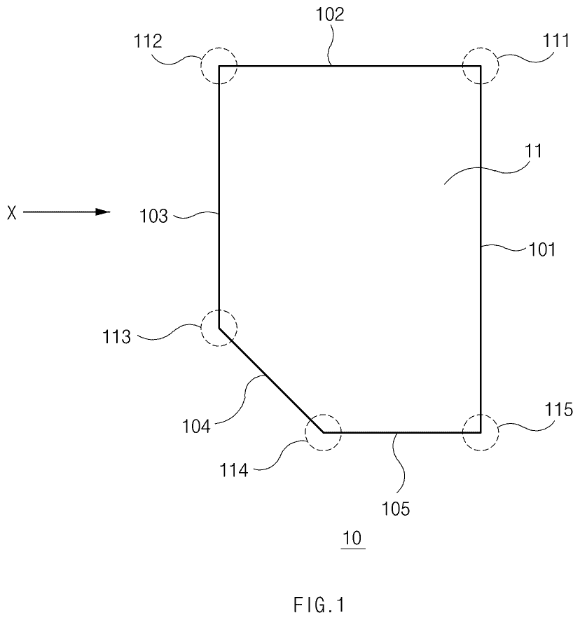

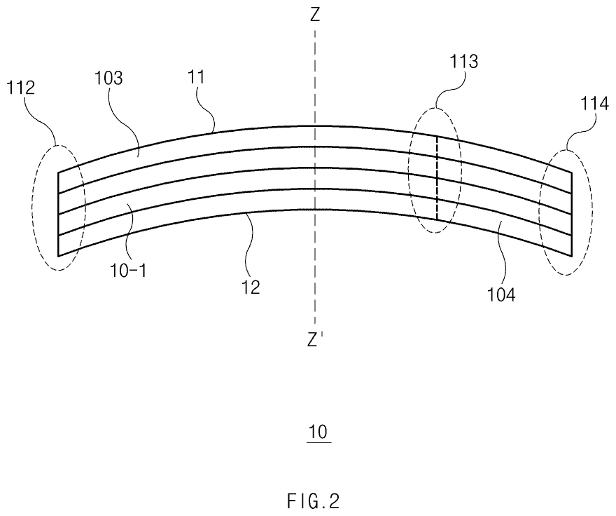

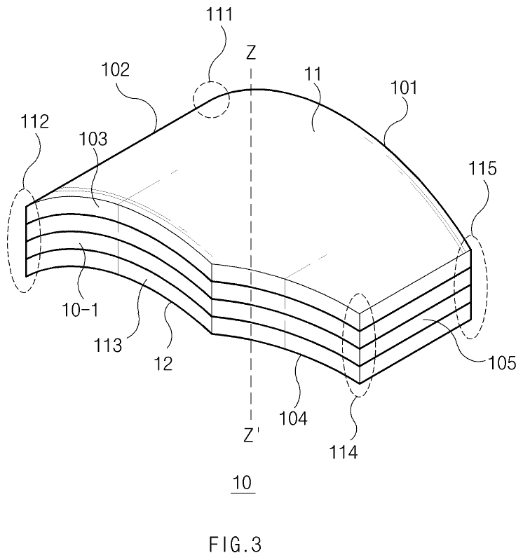

FIG. 1 is a plan view of an electrode stack according to a first aspect of the present disclosure, FIG. 2 is a side view of an electrode stack according to a first aspect of the present disclosure in the X direction, and FIG. 3 is a perspective view of an electrode stack according to a first aspect of the present disclosure.

The electrode stack 10 may include electrodes 10-1. The electrodes 10-1 may be stacked along the vertical stacking direction Z-Z′.

The electrode stack 10 may include an upper surface 11. The upper surface 11 may form the upper outer periphery of the electrodes 10-1 stacked in the vertical stacking direction Z-Z′.

The electrode stack 10 may include a lower surface 12. The lower surface 12 may form the lower outer periphery of the electrodes 10-1 stacked in the vertical stacking direction Z-Z′.

The electrode stack 10 may include side surfaces 101, 102, 103, 104, 105. The side surfaces 101, 102, 103, 104, 105 may form the lateral outer periphery of the electrodes 10-1. Additionally, the side surfaces 101, 102, 103, 104, 105 may connect the upper surface 11 and the lower surface 12 along the stacking direction Z-Z′.

The electrode stack 10 may include corner portions 111, 112, 113, 114, 115.

The corner portions 111, 112, 113, 114, 115 may be formed in different shapes on the upper surface 11 when viewed from above.

The corner portions 111, 112, 113, 114, 115 may include intersecting corner portions. For example, the intersecting corner portion may be a corner portion formed in a shape where straight lines intersect at a predetermined angle when viewed from above.

Some corner portions 111, 112, 115 among the corner portions may be formed in a shape where straight lines are orthogonal to each other. The other corner portions 113, 114 among the corner portions may be formed in a shape where straight lines form a predetermined angle other than a right angle.

Specifically, the intersecting corner portion may include obtuse intersecting corner portions 113, 114. For example, the obtuse intersecting corner portions 113, 114 may be corner portions formed in a shape where straight lines intersect at an obtuse angle. The intersecting corner portion may include a plurality of obtuse intersecting corner portions 113, 114.

The side surfaces 101, 102, 103, 104, 105 may be divided by the corner portions 111, 112, 113, 114, 115.

The side surfaces 101, 102, 103, 104, 105 may include a plurality of planes. For example, the side surfaces 101, 102, 103, 104, 105 may include a plurality of planes divided by the corner portions 111, 112, 113, 114, 115.

The upper surface 11 and the lower surface 12 of the electrode stack 10 may be bent along the stacking direction Z-Z′. For example, as the electrodes 10-1 are bent at a predetermined curvature along the stacking direction Z-Z′, the upper surface 11 and the lower surface 12 may be bent at the predetermined curvature.

The upper surface 11 and the lower surface 12 may be bent in one direction along the stacking direction Z-Z′. For example, the upper surface 11 and the lower surface 12 may be bent upward along the stacking direction Z-Z′.

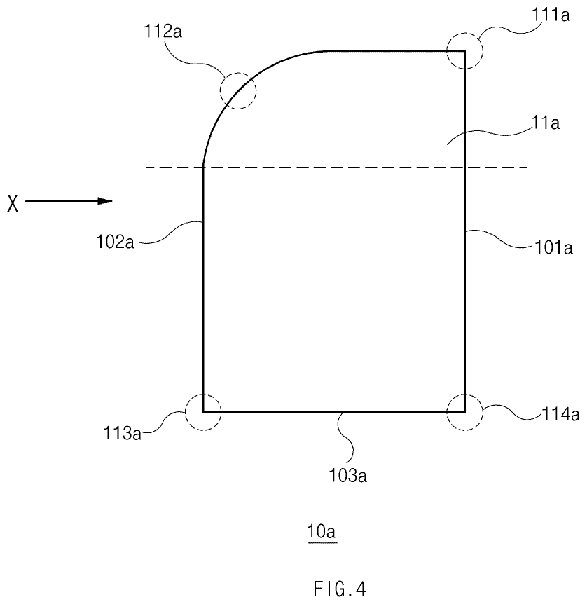

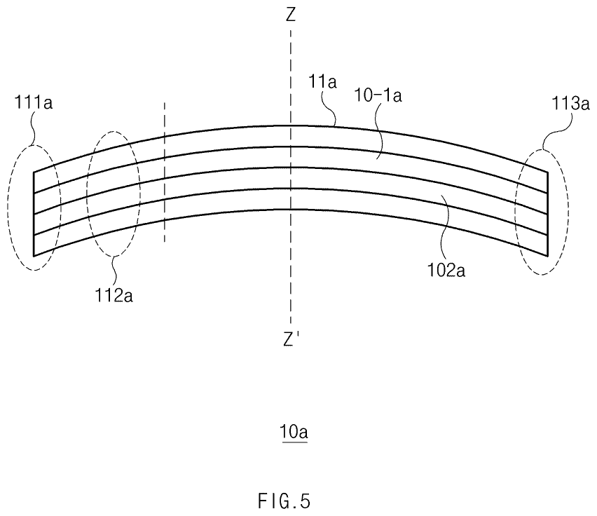

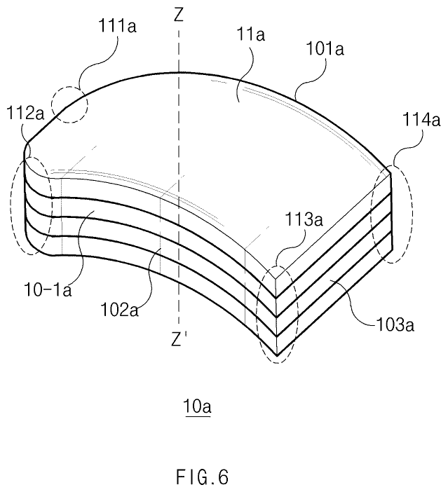

FIG. 4 is a plan view of an electrode stack according to a second aspect of the present disclosure, FIG. 5 is a side view of an electrode stack according to a second aspect of the present disclosure in the X direction, and FIG. 6 is a perspective view of an electrode stack according to a second aspect of the present disclosure. The description of the above-described aspect may be applied equally or similarly to this aspect.

The electrode stack 10a may include corner portions 111a, 112a, 113a, 114a.

The corner portions 111a, 112a, 113a, 114a may include a curved corner portion 112a. The curved corner portion 112a may be a corner portion provided in a curved shape when viewed from above.

The side surfaces 101a, 102a, 103a may include flat and curved surfaces. For example, the electrode stack 10a may include flat side surfaces 101a, 103a and a curved side surface 102a.

The corner portions 111a, 112a, 113a, 114a may include intersecting corner portions 111a, 113a, 114a and a curved corner portion 112a.

When viewed from above, the intersecting corner portions 111a, 113a, 114a may be provided by straight lines that intersect at a predetermined angle, and the curved corner portion 112a may be provided in a curved line. Specifically, when viewed from above, the curved corner portion 112a may be formed in a curved shape between the intersecting corner portion 111a and the intersecting corner portion 113a. In other words, when viewed from above, only the portion corresponding to the curved corner portion 112a on the rectangular upper surface 11 may be formed in a curved shape.

According to the above description, the electrode stack 10a has been described as having one curved corner portion 112a, but may not be limited thereto. For example, the electrode stack 10a may have a plurality of curved corner portions.

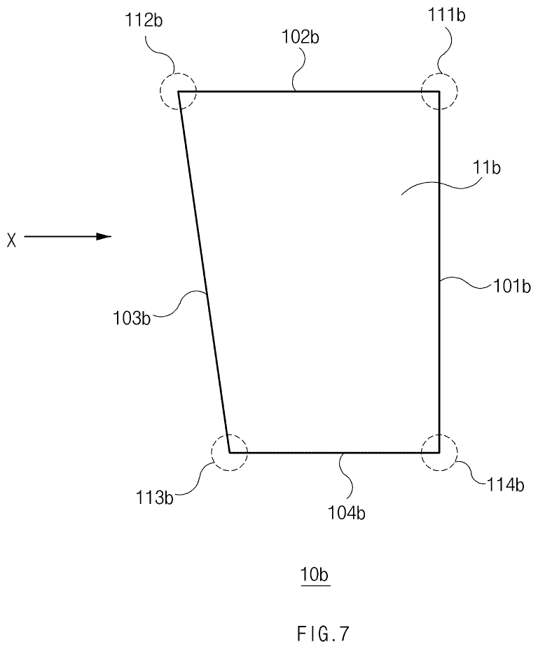

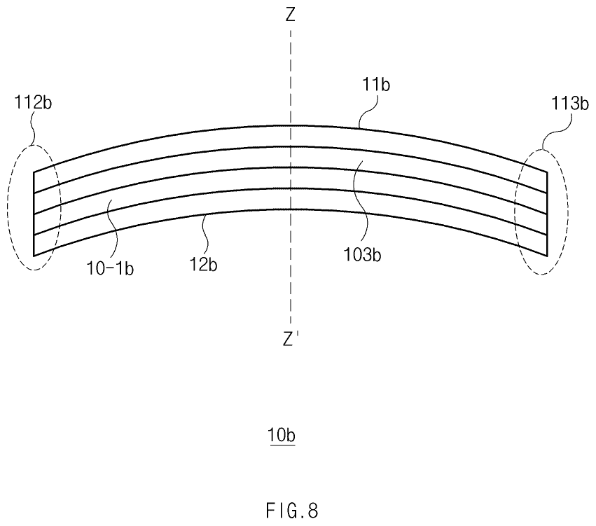

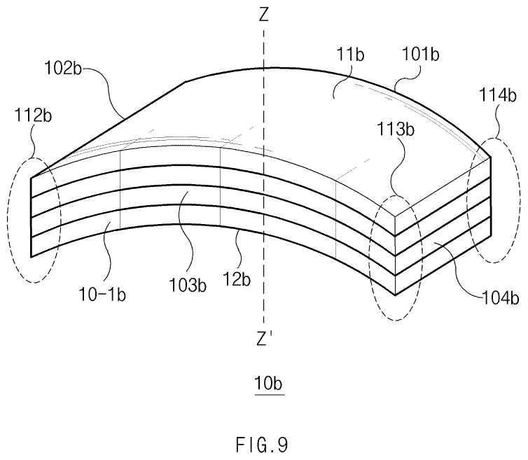

FIG. 7 is a plan view of an electrode stack according to a third aspect of the present disclosure, FIG. 8 is a side view of an electrode stack according to a third aspect of the present disclosure in the X direction, and FIG. 9 is a perspective view of an electrode stack according to a third aspect of the present disclosure. The description of the above-described aspect may be applied equally or similarly to this aspect.

The electrode stack 10b may include corner portions 111b, 112b, 113b, 114b.

The corner portions 111b, 112b, 113b, 114b of the electrode stack 10b may be intersecting corner portions.

The corner portions 111b, 112b, 113b, 114b of the electrode stack 10b may include an acute intersecting corner portion and an obtuse intersecting corner portion.

The acute intersecting corner portion 112b may be a corner portion where straight lines intersect at an acute angle when viewed from above. The obtuse intersecting corner portion 113b may be a corner portion where straight lines intersect at an obtuse angle when viewed from above. The acute angle and the obtuse angle described above may be based on the inner angle of the upper surface 11b. In other words, the upper surface 11b may have a trapezoidal shape.

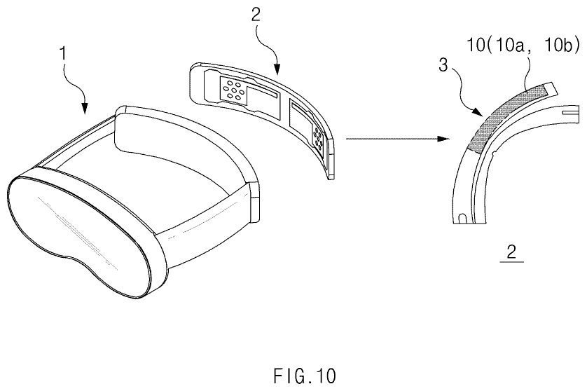

The description of the electrode stacks 10, 10a, 10b described with reference to FIGS. 1 to 9 is an example and is not limited thereto. Specifically, the corner portions of the electrode stacks may be designed in various ways by combining intersecting corner portions and/or curved corner portions.
FIG. 10 is a conceptual view showing a battery system according to an aspect of the present disclosure. The description of the above-described aspect may be applied equally or similarly to this aspect.

The battery system 1 may include a battery unit 2.

The battery unit 2 may perform the function of supplying power to the battery system 1. The battery unit 2 may accommodate the electrode stacks 10, 10a, 10b therein.

The battery unit 2 may include a bending portion 3. For example, the bending portion 3 may have a bent shape that defines a receiving space for accommodating the electrode stacks 10, 10a, 10b therein.

The battery unit 2 may include electrode stacks 10, 10a, 10b. The electrode stacks 10, 10a, 10b may be disposed in the receiving space of the bending portion 3. However, the electrode stacks 10, 10a, 10b may be disposed at locations other than the bending portion 3.

The electrode stacks 10, 10a, 10b may include an upper surface forming the upper outer periphery of the electrodes stacked in the vertical direction, a lower surface forming the lower outer periphery of the electrodes, and side surfaces connecting the upper surface and the lower surface along the stacking direction.

The upper surface and the lower surface may be bent along the stacking direction, and when viewed from above, the upper surface may have corner portions formed in different shapes.

As the electrodes are bent at a predetermined curvature along the stacking direction, the upper surface and the lower surface of the electrode stacks 10, 10a, 10b may be bent at the predetermined curvature.

The upper surface of the electrode stacks 10, 10a, 10b may be disposed to face the bent inner surface of the bending portion 3. The bent inner surface of the bending portion 3 may include a portion bent at a predetermined curvature.

In the above description, the electrode stack is disposed, but it may be equally applied even when the electrode stack is embedded in a case and disposed.

A method of disposing the electrode stacks 10, 10a, 10b in the battery system 1 may include steps to be described later.

The method of disposing the electrode stacks 10, 10a, 10b in the battery system 1 may include a type determination step. The type determination step may be a step of determining the type of electrode stacks 10, 10a, 10b that may be disposed based on the size of the battery unit 2 in which the electrode stacks 10, 10a, 10b may be accommodated inside the battery system 1.

The method of disposing the electrode stacks 10, 10a, 10b in the battery system 1 may include a number determination step. The number determination step may be a step of determining the required number for each type of electrode stacks 10, 10a, 10b.

The method of disposing the electrode stacks 10, 10a, 10b in the battery system 1 may include a placement step. The placement step may be a step of disposing the electrode stacks 10, 10a, 10b based on the type determination and the number determination.

When the bent electrode stacks 10, 10a, 10b are disposed in a curved portion such as the bending portion 3 in the battery system 1, space efficiency may be maximized compared to a case where the unbent electrode stacks are simply stacked.

Space efficiency may be maximized by mixing the above-described bent electrode stacks 10, 10a, 10b with the unbent electrode stacks and disposing them in a manner that fits into the receiving space within the battery system 1.

When the space efficiency within the battery system 1 is maximized through the placement of the electrode stacks 10, 10a, 10b, the battery capacity may be maximized.

The present disclosure has been hereinabove described with regard to a limited number of aspects and drawings, but the present disclosure is not limited thereto and may be embodied in different forms by those having ordinary skill in the technical field pertaining to the present disclosure within the technical aspect of the present disclosure and the scope of the appended claims and their equivalents.

### LIST OF REFERENCE NUMERALS

1: Battery system
2: Battery unit
3: Bending portion
10, 10a, 10b: Electrode stack
11, 11a, 11b: Upper surface
12, 12a, 12b: Lower surface
10-1, 10-1a, 10-1b: Electrodes
101, 101a, 101b: Side surface
102, 102a, 102b: Side surface
103, 103a, 103b: Side surface
104, 104b: Side surface
105: Side surface
111, 111a, 111b: Corner portion
112, 112a, 112b: Corner portion
113, 113a, 113b: Corner portion
114, 114a, 114b: Corner portion
115: Corner portion

1. An electrode stack comprising:
an upper surface forming an upper outer periphery of electrodes stacked in a stacking direction;
a lower surface forming a lower outer periphery of the electrodes; and
side surfaces connecting the upper surface and the lower surface along the stacking direction,
wherein the upper surface and the lower surface are bent along the stacking direction, and
the upper surface has corner portions formed in different shapes.

2. The electrode stack according to claim 1,
wherein the side surfaces comprise a plurality of planes.

3. The electrode stack according to claim 1,
wherein the side surfaces comprise flat surfaces and curved surfaces.

4. The electrode stack according to claim 1,
wherein the electrodes are bent at a predetermined curvature along the stacking direction, such that the upper surface and the lower surface are bent at the predetermined curvature.

5. The electrode stack according to claim 1,
wherein the upper surface and the lower surface are bent in one direction along the stacking direction.

6. The electrode stack according to claim 1,
wherein the corner portions comprise intersecting corner portions comprising straight lines that intersect at a predetermined angle.

7. The electrode stack according to claim 6,
wherein the intersecting corner portions comprise a plurality of obtuse intersecting corner portions.

8. The electrode stack according to claim 6,
wherein the intersecting corner portions comprise an acute intersecting corner portion and an obtuse intersecting corner portion.

9. The electrode stack according to claim 6,
wherein the corner portions further comprise a curved corner portion.

10. The electrode stack according to claim 1,
wherein the upper surface and the lower surface are bent at a predetermined curvature, and
the corner portions comprise:
intersecting corner portions provided with straight lines that intersect at a predetermined angle; and
a curved corner portion.

11. A battery system comprising:
a battery unit having a bending portion having a bent shape that defines a receiving space for accommodating an electrode stack therein; and
an electrode stack disposed in the receiving space,
wherein the electrode stack comprises:
an upper surface forming an upper outer periphery of electrodes stacked in a stacking direction;
a lower surface forming a lower outer periphery of the electrodes; and
side surfaces connecting the upper surface and the lower surface along the stacking direction,
wherein the upper surface and the lower surface are bent along the stacking direction, and
the upper surface has corner portions formed in different shapes.

12. The battery system according to claim 11,
wherein the electrodes are bent at a predetermined curvature along the stacking direction, and the upper surface and the lower surface are bent at the predetermined curvature, and
wherein the upper surface is disposed to face a bent inner surface of the bending portion.

13. The battery system according to claim 12,
wherein the bent inner surface comprises a portion bent at the predetermined curvature.

14. The battery system according to claim 11,
wherein the corner portions comprise a curved corner portion.

15. The battery system according to claim 14,
wherein the corner portions further comprise intersecting corner portions comprising straight lines that intersect at a predetermined angle.
